(19) United States
(12) Patent Application Publication
(10) Pub. No.: US 2009/0296592 A1
(43) Pub. Date: Dec. 3, 2009

(54) METHOD AND APPARATUS OF MEASURING AND REPORTING DATA GAP FROM WITHIN AN ANALYSIS TOOL

(75) Inventor: Dan Prescott, Elbert, CO (US)

Correspondence Address: PATENTTM.US, P. O. BOX 82788, PORTLAND, OR, 97282-0788, US

(73) Assignee: Fluke Corporation, Everett, WA (US)

(21) Appl. No.: 12/128,503

(22) Filed: May 28, 2008

(51) Int. Cl. H04L 12/26

(52) U.S. Cl. 370/252

(57) ABSTRACT

Network data gap is determined and reported to enable a user to validate that all the traffic that was intended to be monitored is being monitored in monitoring and/or troubleshooting tools for observation of network traffic and network installation and maintenance. Span port oversubscription, incomplete span configuration, incorrectly placed network taps and monitoring device packet drop may thereby be detected and reported as data gap.

### BACKGROUND OF THE INVENTION

This invention relates to networking, and more particularly to monitoring and analysis of network traffic.

In a computer networking environment, users may install and deploy monitoring and/or troubleshooting tools for observation of network traffic and network installation and maintenance. It is common to configure a set of network span or mirror ports on a switch/router/etc., install network taps, install devices inline, etc. A network span or mirror combines the data from multiple (one or more) network interfaces on a switch/router/etc. such that the data can be exported on a single port. The network monitoring and analysis devices can then get extended visibility across numerous network segments from a single interface. A network tap allows the user to install a device inline between points on a network and gain similar extended visibility into the network segments.

In many cases, the network environment is complex enough that, with the best intentions, a user will install taps or spans incorrectly. Typical configuration issues include but are not limited to:

1. Oversubscription of the span (including too many hi-bandwidth data flows such that the amount of data aggregated across the spanned ports can exceed available throughput capacity of the span port).
2. Incorrectly places taps (placement such that part of the data is missing due to the route the data takes across the network).
3. Incomplete configuration (span or tap configuration such that part of the data is missing).
4. Monitoring device dropping data (the device receiving the data is unable to process all of the data).

These issues can result in false determination that network problems exist, leading to wasted time and resources trying to track non-existent network problems.

### SUMMARY OF THE INVENTION

In accordance with the invention, measurement and reporting when a network monitoring device missing data is provided.

Accordingly, it is an object of the present invention to provide an improved network analysis that reports when network data is missing from the analysis data.

It is a further object of the present invention to provide an improved network monitoring device that measures and reports that data is missing.

It is yet another object of the present invention to provide improved methods of network monitoring and analysis to measure and report missing data.

Another object of the invention is to provide an improved way for a user to validate that all the traffic that was intended to be monitored is being monitored.

A further object of the invention is to provide a monitoring device and method to accurately determine when a transaction has completed and a new transaction should be denoted.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a network with a network analysis product interfaced therewith;

FIG. 2 is a block diagram of a monitor device for measurement and reporting of missing data;

FIG. 3 is a flow diagram illustrating the missing data and analysis to determine missing data; and

FIG. 4 is a flow chart of determination steps.

### DETAILED DESCRIPTION

The system according to a preferred embodiment of the present invention comprises a monitoring system and method and an analysis system and method for determining and reporting data gap.

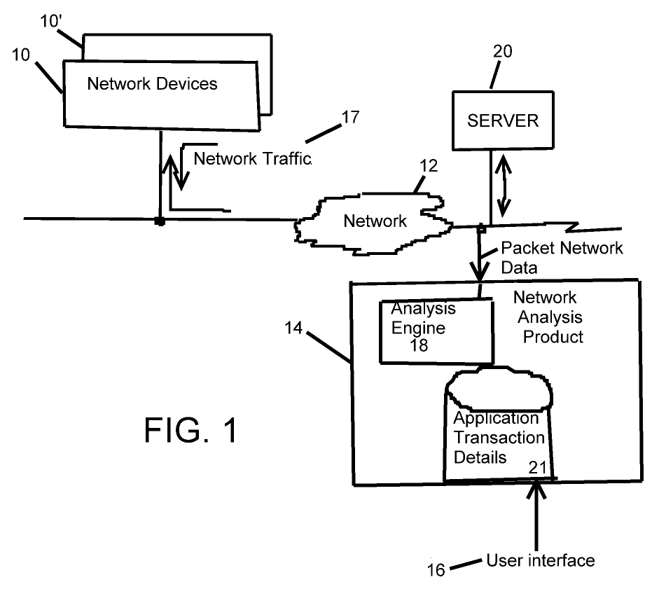

Referring to FIG. 1, a block diagram of a network with an apparatus in accordance with the disclosure herein, a network may comprise plural network devices 10, 10′, etc., which communicate over a network 12 by sending and receiving network traffic 17. The traffic may be sent in packet form, with varying protocols and formatting thereof.

A network analysis product 14 is also connected to the network, and may include a user interface 16 that enables a user to interact with the network analysis product to operate the analysis product and obtain data therefrom, whether at the location of installation or remotely from the physical location of the analysis product network attachment.

The network analysis product comprises hardware and software, CPU, memory, interfaces and the like to operate to connect to and monitor traffic on the network, as well as performing various testing and measurement operations, transmitting and receiving data and the like. When remote, the network analysis product typically is operated by running on a computer or workstation interfaced with the network.

The analysis product comprises an analysis engine 18 which receives the packet network data and interfaces with application transaction details database 21.

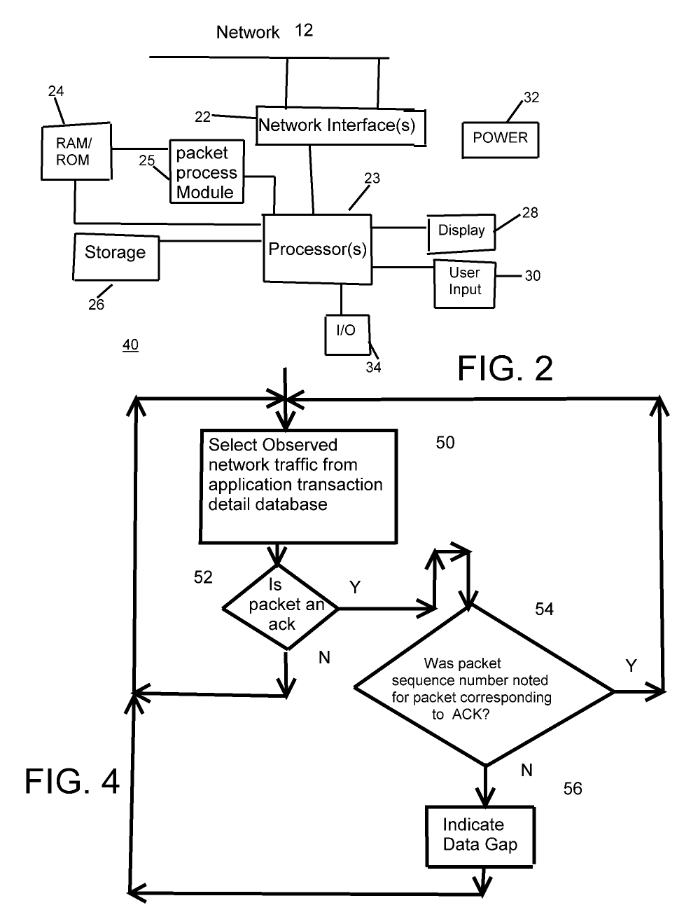

FIG. 2 is a block diagram of a test instrument/analyzer 40 via which the invention can be implemented, wherein the instrument may include network interfaces 22 which attach the device to a network 12 via multiple ports, one or more processors 23 for operating the instrument, memory such as RAM/ROM 24 or persistent storage 26, display 28, user input devices 30 (such as, for example, keyboard, mouse or other pointing devices, touch screen, etc.), power supply 32 which may include battery or AC power supplies, other interface 34 which attaches the device to a network or other external devices (storage, other computer, etc.). Packet processing module 25 provides processing of packets and storage of data related thereto for use in the analysis product to assist in the measuring and reporting of data gap, as discussed further herein.

In operation, the network test instrument is attached to the network, and observes transmissions on the network to collect statistics thereon.

As sufficient data has been collected and stored in applications transaction details database 21, analysis may be performed thereon to measure and report data gap.

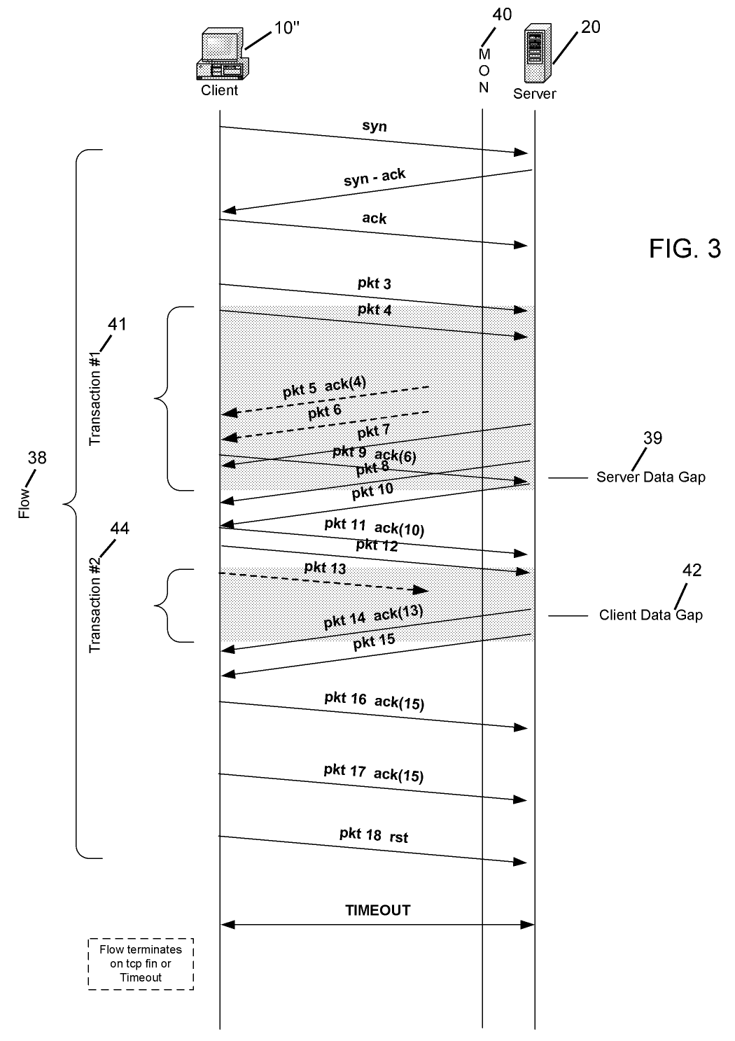

FIG. 3 is a flow diagram illustrating the environment and operation of the invention. Client 10″ and server 20 are illustrated with the space therebetween illustrating the network and traffic. Monitor device 40 is illustrated as observing network traffic at a position on the network. In the illustrated example 2 TCP transactions are shown with data gaps being determined. Communication between client 10″ and server 20 begins with a syn/syn-ack/ack handshake between client and server, to establish the start of a TCP flow (socket connection) 38. Client 10″ then sends packets pkt3 and pkt4. All these transactions are observed by the monitor 40. Server 20 then sends pkt5 (an ack from the server of pkt4 from the client) and pkt6, which are not observed by the monitor 40 in this example, and are accordingly illustrated with dashed lines. Pkt7 and pkt8 from the server to client are sent and observed by monitor 40, as is pkt9 from client to server, which is an ack of pkt6. Monitor 40 notes that pkt9 is an ack of a packet that was never observed by the monitor, and therefore a server data gap 39 is noted by the monitor. Pkt10 is sent from server to client. Transaction number 1 (41) is then determined to be the packets pkt3 through pkt10.

Pkt11, an ack from the client of pkt10 is next sent, followed by pkt12 and pkt13 from the client, pkt13 not being observed by the monitor.

Pkt14 is an ack of pkt13 and the monitor, observing the pkt14 but not having seen pkt13, notes a client data gap 42. Pkt15 is then sent from the server to the client, pkt12-pkt15 being transaction #2, 44.

The client sends pkt16 and pkt17 which are both acks of pkt15, and pkt18 which is a rst. On timeout, a period of time without any traffic between client and server, flow 38 is determined to have terminated in the illustrated example. Flow may be determined to have terminated on timeout as in the example, or on a TCP fin packet.

In accordance with the above description, data gap measurement, measured at the flow and transaction, is taken as an instance count where the analysis tool (mon 40) detects and acknowledgment from either the client or server where the analysis tool has not seen that sequence number from the other side (server or client side). In the above example, in transaction #1, the server sent packets that were not visible to the analysis tool. The client did receive those packets and sent acknowledgment. When the analysis tool got the acknowledgment it was able to make a determination that a server side data gap exists.

In transaction #2 above, the client sent a packet that was not visible to the analysis tool. The server did receive the packet and sent an acknowledgment. When the analysis tool got the acknowledgment it was able to make a determination that a client side data gap exists.

The analysis of the data may be made based on the data stored in application transactions details 21 in near real time or later as a post processing analysis of data collected over a period of time.

FIG. 4 is a flow chart of the analysis process in analyzing observed network traffic data from the application transaction detail database. In block 50, data from the applications transaction details data 21 is selected. If the packet is not an ack (decision block 52), processing continues back to block 50 to select further data. If the packet is an ack, processing continues to decision block 54 to determine whether the packet sequence number corresponding to the ack sequence number was noted. If it was noted, processing continues back to block 50 to select further data. If the ack was for a packet sequence number that had not previously been noted, then in block 56, a data gap occurrence is indicated. Processing may then continue with additional data.

The noted data gap information may then be stored and reported with information regarding which client and which server was involved, whether it was a client or server data gap, and further information that may be of assistance to the user to help determine the mis-placement or mis-configuration of the monitoring equipment, taps or spans or other issues that are resulting in the data gap.

The data gap analysis may be implemented as a part of a network test instrument, or may be separately provided to process data gathered by a network test instrument.

In accordance with the above, the invention provides an intuitive and easy-to-use way for a user to validate that all the traffic that was intended to be monitored is being monitored. In addition, the invention allows the monitoring device to accurately determine when a transaction has completed and a new transaction should be created. In the event that the monitoring device is only seeing one side of a conversation, the invention allows the user to quickly see the root cause and therefore allows the user to correct the issue without wasting time trying to track non-existent network problems.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A network analysis device, comprising:
a network traffic observing unit for observing network traffic data and compiling transaction details data; and
a data gap analysis device for determining existence of data gap in the compiled network traffic transaction details data.

2. The network analysis device according to claim 1, wherein said data gap analysis device includes packet processing for processing the observed network packet data to determine for any ack packet, whether a corresponding packet sequence number was noted, and if not, indicating data gap.

3. A method of analyzing network traffic data to determine data gap, comprising:
selecting a packet of network traffic;
determining if said selected packet is an ack;
if said packet is an ack, then determining whether a sequence number of a packet corresponding to said ack had been noted, and if not noted, indicating a data gap.

4. A method of analyzing network traffic data to determine data gap, comprising:
observing network traffic data and determining transaction details therefrom;
storing said determined transaction details;
analyzing said stored determined transaction details to determine existence of data gap.

5. The method according to claim 4, further comprising the step of reporting the results of determined existence of data gap.

6. The method according to claim 4, wherein said analyzing comprises:
selecting a transaction detail for a packet of network traffic;
determining if said selected transaction detail represents an ack packet;
if said transaction detail represents an ack packet, then determining whether a sequence number of a packet corresponding to said ack packet had been noted, and if not noted, indicating existence of a data gap.

7. The method according to claim 4, wherein said analyzing said stored determined transaction details to determine existence of data gap is performed at a location physically away from a location where said observing occurred.

8. The method according to claim 4, wherein said analyzing said stored determined transaction details to determine existence of data gap is performed as a post processing step in other than real time relative to said observing and storing.

9. The method according to claim 4, wherein said analyzing said stored determined transaction details to determine existence of data gap is performed as a substantially real time operation relative to said observing and storing.

10. A network test instrument, comprising:
network interface for receiving network traffic;
a network traffic observing unit for observing received network traffic data and compiling transaction details data;
a data gap analysis device for determining existence of data gap in the compiled network traffic transaction details data;
a user interface for interacting with a user for receiving operating instructions and reporting determination results.

11. The network analysis device according to claim 10, wherein said data gap analysis device includes packet processing for processing the observed network packet data to determine for any ack packet, whether a corresponding packet sequence number was noted, and if not, indicating data gap.

12. The network analysis device according to claim 11, wherein said packet processing is performed in substantially real time relative to said observing and compiling.

13. The network analysis device according to claim 11, wherein said packet processing is performed in other than real time relative to said observing and compiling.
